(19) United States
(12) Patent Application Publication
(10) Pub. No.: US 2026/0368165 A1
(43) Pub. Date: Nov. 19, 2026

(54) MULTI-TIER CACHING OF LANGUAGE MODEL QUERIES

(71) Applicant: Dell Products L.P., Round Rock, TX (US)

(72) Inventors: Pankaj Pande, Carlingford (AU); Gaurav Chawla, Austin, TX (US)

(21) Appl. No.: 19/211,511

(22) Filed: May 19, 2025

(51) Int. Cl. G06F 16/2453

(52) U.S. Cl. CPC G06F 16/24539

(57) ABSTRACT

Techniques are provided for multi-tier caching of language model queries. One method comprises determining a query complexity score of a query; evaluating a similarity of the at least one query relative to a plurality of previous queries stored in a given caching tier of a multi-tier cache, wherein the multi-tier cache comprises different caching tiers (i) associated with respective ones of different query complexity levels, and (ii) comprising respective ones of different types of storage devices having different performance characteristics, wherein the given caching tier is identified based on the determined query complexity score of the query; and generating query response to the query, in response to the similarity evaluation determining that the query does not have a similar query in the multi-tier cache, by applying the query to at least one language model.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Some artificial intelligence techniques are trained to answer various user queries (e.g., questions). As workloads for such artificial intelligence-based query-response techniques grow in complexity, repeated queries, often with subtle semantic variations, may cause system inefficiencies, increased latency and/or increased token costs.

### SUMMARY

Illustrative embodiments of the disclosure provide techniques for multi-tier caching of language model queries. One method includes obtaining at least one query; determining a query complexity score of the at least one query; evaluating a similarity of the at least one query relative to a plurality of previous queries stored in a given caching tier of a multi-tier cache, wherein the multi-tier cache comprises a plurality of different caching tiers (i) associated with respective ones of a plurality of different query complexity levels, and (ii) comprising respective ones of a plurality of different types of storage devices having different performance characteristics, wherein the given caching tier is identified based at least in part on the determined query complexity score of the at least one query; and generating at least one query response to the at least one query, in response to the similarity evaluation determining that the at least one query does not have a similar query in the multi-tier cache based on one or more designated similarity criteria, by applying the at least one query to at least one language model.

Illustrative embodiments can provide significant advantages relative to conventional techniques. For example, technical problems related to such conventional techniques, such as responsiveness challenges, are mitigated in one or more embodiments by retrieving a response stored in a given tier of a multi-tier cache, where the multi-tier cache comprises multiple cache tiers each (i) comprising different types of storage devices having different performance characteristics and (ii) being associated with different query complexity levels, where the given tier is identified using a query complexity value.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for multi-tier caching of language model queries in accordance with an illustrative embodiment;

FIG. 2 illustrates exemplary routing logic for a multi-tier cache in accordance with an illustrative embodiment;

FIG. 3 is a flow diagram illustrating an exemplary implementation of a process for multi-tier caching of language model queries in accordance with an illustrative embodiment;

FIG. 4 is a flow diagram illustrating an exemplary implementation of a multi-tier cache retrieval process in accordance with an illustrative embodiment;

FIG. 5 illustrates a processing of queries predicted by a query prediction engine in accordance with an illustrative embodiment;

FIG. 6 is a process diagram illustrating an exemplary implementation of a query complexity prediction process in accordance with an illustrative embodiment;

FIG. 7 is a process diagram illustrating an exemplary implementation of a semantic query clustering process in accordance with an illustrative embodiment;

FIG. 8 is a process diagram illustrating an exemplary implementation of a query prediction process in accordance with an illustrative embodiment;

FIG. 9 is a process diagram illustrating an exemplary implementation of a reinforcement learning (RL)-based cache partitioning process in accordance with an illustrative embodiment;

FIG. 10 is a process diagram illustrating an exemplary implementation of a user-centric policy adjustment process in accordance with an illustrative embodiment;

FIG. 11 is a process diagram illustrating an exemplary implementation of an adaptive multi-tier caching process in accordance with an illustrative embodiment;

FIG. 12 is a flow diagram illustrating an exemplary implementation of a process for multi-tier caching of language model queries in accordance with an illustrative embodiment;

FIG. 13 illustrates an exemplary processing platform that may be used to implement at least a portion of one or more embodiments of the disclosure comprising a cloud infrastructure; and

FIG. 14 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for multi-tier caching of language model queries.

In one or more embodiments, the disclosed multi-tier caching techniques employ adaptive cache tier partitioning, real-time query complexity prediction and semantic clustering to improve (e.g., optimize) query processing. The disclosed multi-tier caches may comprise multiple cache tiers each (i) comprising different types of storage devices having different performance characteristics and (ii) being associated with different query complexity levels. For example, in one embodiment, a tier zero cache may comprise an in-memory cache; a tier one cache may comprise a solid-state drive (SSD) cache and a tier two cache may comprise a distributed object store. The multi-tier cache may selectively cache previous queries and/or query responses in one or more tiers of the multi-tier cache.

A new query may be routed to a given tier, using a determined query complexity value, of the multi-tier cache. In some embodiments, a query frequency may also be considered in the cache tier selection for a given query. In this manner, some embodiments provide for a joint optimization of frequency and complexity to assign new queries to the appropriate cache tier. A complexity-aware router may direct each new query to the appropriate cache tier of the multi-tier cache. For example, the tier zero cache may handle high-frequency, low-complexity queries for prompt access; the tier one cache may handle medium-complexity queries requiring faster access than distributed caches; and the tier two cache may handle low-frequency, high-complexity queries, for example, in cloud-based storage, to reduce latency.

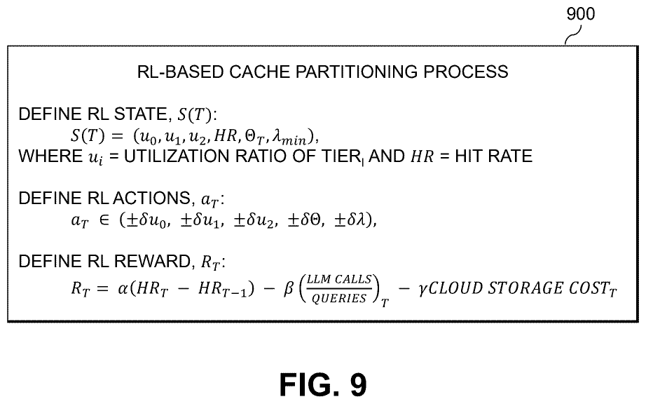

In some embodiments, RL techniques are employed to perform adaptive cache tier partitioning by dynamically adjusting a size and resource allocation of each cache tier in the multi-tier cache based on real-time query patterns, as discussed further below in conjunction with FIG. 9. For example, frequently accessed cache tiers (e.g., during peak hours) may receive more resources, while underused cache tiers may receive fewer resources. By combining multi-tier caching with adaptive cache partitioning, in some embodiments, the disclosed multi-tier caching techniques ensure that cache resources are distributed where they are most needed. In this manner, a size of each cache tier in the multi-tier cache may be automatically adjusted based on real-time demand, ensuring that high-frequency data is accessible while less critical data may remain in less accessible cache tiers. In addition, RL techniques may be employed to update query prediction models and clustering algorithms to ensure improved (e.g., optimal) performance.

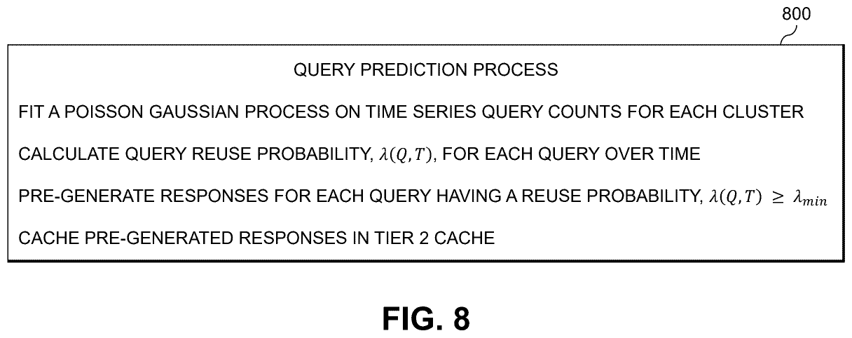

A proactive forecast engine may identify queries having a high likelihood of reuse (e.g., a high likelihood of being a repeated query, possibly with subtle semantic variations), as discussed further below in conjunction with FIG. 8, for example, in order to preload appropriate query responses in the multi-tier cache, before a user submits the corresponding query.

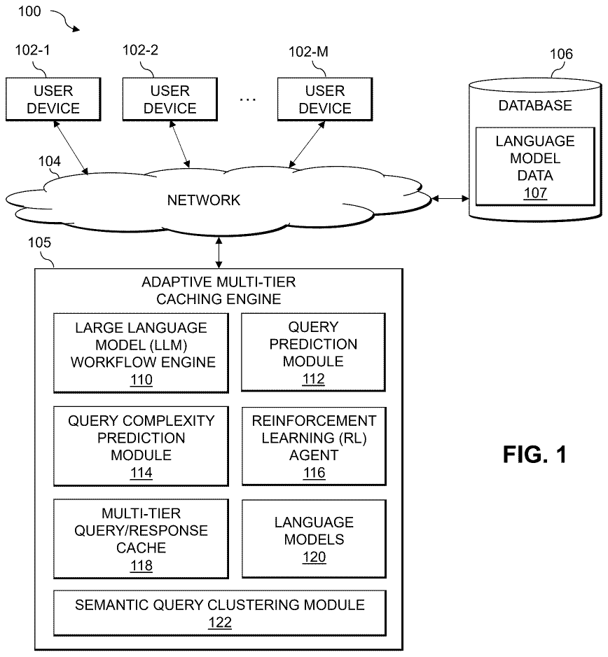

FIG. 1 shows an information processing system 100 configured in accordance with an illustrative embodiment. The information processing system 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger information processing system 100. Also coupled to network 104 is an adaptive multi-tier caching engine 105 and a database system 106.

The user devices 102 may comprise, for example, devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the information processing system 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the information processing system 100, including a wide area network (WAN), a local area network (LAN), a satellite network, a telephone or cable network, a cellular network, a wireless network such as a Wi-Fi or WiMAX network, or various portions or combinations of these and other types of networks. The information processing system 100 in some embodiments therefore comprises combinations of multiple different types of networks, each comprising processing devices configured to communicate using internet protocol (IP) or other related communication protocols.

The adaptive multi-tier caching engine 105 may comprise a large language model (LLM) workflow engine 110, a query prediction module 112, a query complexity prediction module 114, an RL agent 116, a multi-tier query/response cache 118, one or more language models 120 and a semantic query clustering module 122.

The multi-tier query/response cache 118 may comprise multiple cache tiers each (i) comprising different types of storage devices having different performance characteristics and (ii) being associated with different query complexity levels, where the given tier is identified using a query complexity value. For example, in one embodiment, a tier zero cache may comprise an in-memory (e.g., a dynamic random-access memory (DRAM)) cache; a tier one cache may comprise an SSD cache (or another disk-based cache) and a tier two cache may comprise a distributed object store (e.g., an S3-class object store). The multi-tier query/response cache 118 may selectively cache previous queries and/or query responses in one or more tiers of the multi-tier query/response cache 118.

The query prediction module 112 determines a likelihood of a query being reused (e.g., a repeated query, possibly with subtle semantic variations), as discussed further below in conjunction with FIG. 8, for example.

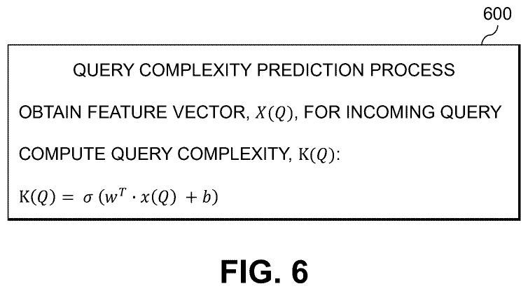

The query complexity prediction module 114, in some embodiments, may employ a machine learning model to predict a complexity score for each incoming query in real time, as discussed further below in conjunction with FIG. 6, ensuring, for example, that simple queries are routed to a fast, high-priority cache tier and complex queries may be processed more efficiently through deeper cache tiers in a lower priority cache tier.

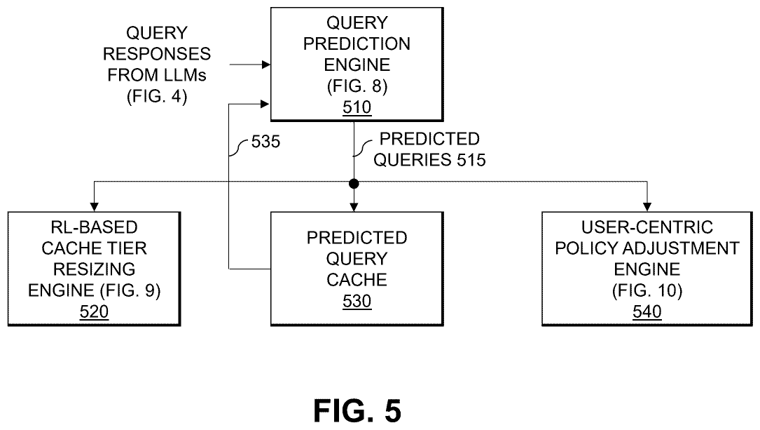

The RL agent 116 may update an allocation of storage resources among the various tiers of the multi-tier query/response cache 118 and update expiration values for various entries cached in the multi-tier query/response cache 118, as discussed further below in conjunction with FIG. 5, for example.

In one or more embodiments, new queries may be passed through the LLM workflow engine 110, which can assign a new query to a given tier of the multi-tier query/response cache 118 using the complexity score assigned by the query complexity prediction module 114, and can generate a common word embedding vector in some embodiments for each query and perform other tasks for processing queries. A word embedding vector may be generated, for example, using an embedding method such as term frequency-inverse document frequency (TF-IDF), latent semantic analysis (LSA), GloVe, Word2Vec, etc.

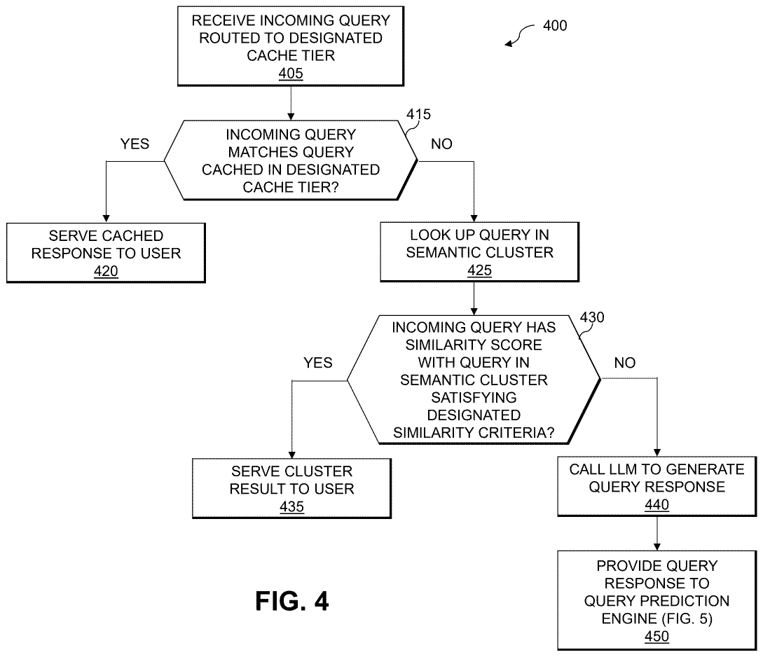

Once a new query is assigned to a given tier of the multi-tier cache, the LLM workflow engine 110 may initiate the process of FIG. 4, for example, to evaluate the similarity of the new query with respect to previous queries cached in the multi-tier query/response cache 118. The new query can be applied to one or more of the language models 120 if the new query is not determined to be similar to previous queries cached in the multi-tier query/response cache 118, as discussed further below in conjunction with FIG. 4.

The one or more language models 120 may comprise, for example, LLMs or other models that can generate text and perform natural language processing (NLP) tasks, that determine a response to a user of a respective user device 102, as discussed herein. The language models 120 may learn statistical relationships from a training dataset comprised of text documents using a self-supervised training process and/or a semi-supervised training process, for example.

The term “language model” as used herein is intended to be broadly construed so as to encompass, for example, natural language processing models trained on textual data to understand, generate, predict and/or summarize new content. The language models 120 may be implemented, for example, using transformer-based architectures that process input through a sequence of transformers, where each transformer includes a self-attention layer and a feedforward layer. Generally, the self-attention layer computes an importance of each token in a sequence of input tokens, and the feedforward layer transforms the output of the self-attention layer into a form that is suitable for the next transformer in the sequence.

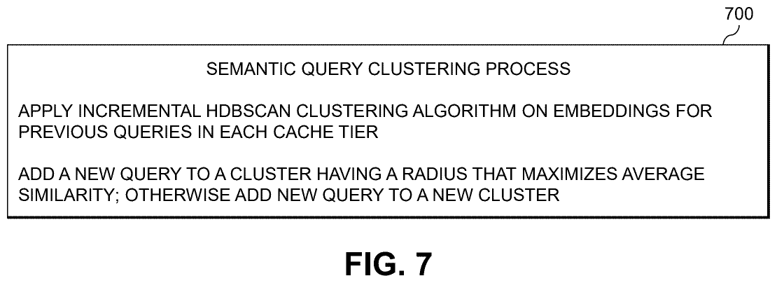

In one or more embodiments, the semantic query clustering module 122 may implement the semantic query clustering process 700 of FIG. 7 to assign a new query to a cluster.

It is to be appreciated that this particular arrangement of elements 110, 112, 114, 116, 118, 120 and/or 122 illustrated in the adaptive multi-tier caching engine 105 of the FIG. 1 embodiment is presented by way of example only, and alternative arrangements can be used in other embodiments. For example, the functionality associated with the elements 110, 112, 114, 116, 118, 120 and/or 122 in other embodiments can be combined into a single module, or separated across a larger number of modules. As another example, multiple distinct processors can be used to implement different ones of the elements 110, 112, 114, 116, 118, 120 and/or 122 or portions thereof.

At least portions of elements 110, 112, 114, 116, 118, 120 and/or 122 may be implemented at least in part in the form of software that is stored in memory and executed by a processor.

Additionally, the database system 106 may comprise one or more databases, such as language model data 107 comprising data pertaining to, for example, historical queries, input queries, query embeddings, query token count data, query similarity score data, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The language model data 107 may be configured to store data, for example, in tables, in a known manner. While the database system 106 is illustrated in FIG. 1 as a single database, at least portions of the database system 106 may be implemented as multiple distinct databases. Example database system 106, such as depicted in the present embodiment, can be implemented using one or more storage systems associated with the adaptive multi-tier caching engine 105. Such storage systems can comprise any of a variety of different types of storage including network-attached storage (NAS), storage area networks (SANs), direct-attached storage (DAS) and distributed DAS, as well as combinations of these and other storage types, including software-defined storage.

At least one embodiment includes obtaining and/or intercepting a user prompt and/or query (after submission via at least one of user devices 102, for example) and verifying if the prompt and/or query has already been submitted using the adaptive multi-tier caching engine 105, as discussed herein. If the prompt and/or query is determined to be sufficiently different from the previously submitted historical prompts and/or queries, one or more embodiments can include processing the prompt and/or query to determine a query response.

Also associated with the adaptive multi-tier caching engine 105 are one or more input-output devices, which illustratively comprise keyboards, displays or other types of input-output devices in any combination. Such input-output devices can be used, for example, to support one or more user interfaces to the adaptive multi-tier caching engine 105, as well as to support communication between adaptive multi-tier caching engine 105 and other related systems and devices not explicitly shown.

Additionally, the adaptive multi-tier caching engine 105 in the FIG. 1 embodiment is assumed to be implemented using at least one processing device. Each such processing device generally comprises at least one processor and an associated memory, and implements one or more functional modules for controlling certain features of the adaptive multi-tier caching engine 105.

More particularly, the adaptive multi-tier caching engine 105 in this embodiment can comprise a processor coupled to a memory and a network interface.

The processor illustratively comprises a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage drive, a storage array or an integrated circuit containing memory, as well as a wide variety of other types of computer program products. The term “article of manufacture” as used herein should be understood to exclude transitory, propagating signals. These and other references to “drives” herein are intended to refer generally to storage devices, including solid-state drives (SSDs), and should therefore not be viewed as limited in any way to particular storage media types.

The network interface allows the adaptive multitier layer caching engine 105 to communicate over the network 104 with the user devices 102, and illustratively comprises one or more conventional transceivers.

It is to be understood that the particular set of elements shown in FIG. 1 for the adaptive multi-tier caching engine 105 involving user devices 102 of information processing system 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the adaptive multi-tier caching engine 105 and at least portions of the database system 106 can be on and/or part of the same processing platform.

In one or more embodiments, the adaptive multi-tier caching engine 105 may be configured to cache a query (e.g., a request or prompt) and a corresponding query response (e.g., generated by a given language model). More particularly, after determining a complexity of the query, the adaptive multi-tier caching engine 105 may route the query to a given tier of the multi-tier cache to determine if the same or similar query was processed previously and cached in the designated cache tier. If a same or similar query was found in the designated cache tier of the multi-tier query/response cache 118, the corresponding query response can be retrieved from the multi-tier query/response cache 118 and returned, thus eliminating the need to process the query using a language model, which can improve the performance and reduce the cost of the language models. If a same or similar query was not found in the designated cache tier of the multi-tier query/response cache 118, or in a semantic cluster associated with the designated cache tier of the multi-tier query/response cache 118, a query response can be generated by one or more language models.

In one or more embodiments, data to be cached in the multi-tier query/response cache 118 can include, e.g., a hash created of the vector of the query, search domain identifying information (e.g., user, role, program and/or chatbot identifier (ID)), the entire vector of the query as generated from vectorization, the token size of the query, and the response from the language model.

By way merely of example, in connection with text analysis, one or more embodiments can include using cosine similarity to compare the orientation of two text documents as vectors in a multi-dimensional space. By calculating the cosine of the angle between these two vectors, such an embodiment can include deriving a similarity score (e.g., a score ranging from −1 to 1, wherein 1 indicates that the vectors are perfectly aligned (indicating identical direction and maximum similarity), 0 indicates orthogonality (i.e., no similarity), and −1 represents completely opposite directions). In such an embodiment, a score closer to 1 indicates a high degree of similarity and a score closer to 0 indicates dissimilarity.

Any query to a language model can be broken up into tokens during encoding, and relevant token count rules may be applied to each language model. By way merely of example, tokens can represent words and/or other characters (such as commas) in the query. Also, language models can often support different token count limits.

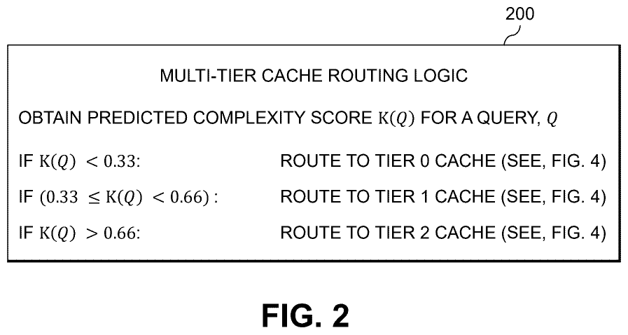

FIG. 2 illustrates exemplary routing logic 200 for a multi-tier cache in accordance with an illustrative embodiment. Let Q be an incoming query string having an arrival timestamp, T. The incoming query is routed to a particular tier of the multi-tier cache based at least in part on a determined query complexity score, K(Q) (e.g., in a range of 0 to 1), as discussed further below in conjunction with FIG. 6.

In the example of FIG. 2, a predicted complexity score, K(Q), is obtained for a query, Q. If the predicted complexity score, K(Q), is in a first range (e.g., if K(Q)<0.33), then the incoming query is routed to the tier 0 cache. If the predicted complexity score, K(Q), is in a second range (e.g., if (0.33≤K(Q)<0.66), then the incoming query is routed to the tier 1 cache. If the predicted complexity score, K(Q), is in a third range (e.g., if K(Q)>0.66), then the incoming query is routed to the tier 2 cache.

It is noted that the routing of an incoming query to a respective tier involves the respective tier determining if the incoming query (i) matches a query cached in the respective tier (e.g., by evaluating a query-dependent value, such as a hash value, of the incoming query compared to queries cached in the respective tier) or (ii) has a semantic similarity score, with respect to one or more queries in at least one sematic cluster associated with the respective tier, that satisfies one or more designated similarity criteria, as discussed further below in conjunction with FIG. 4. In the event that the incoming query does not match a query cached in the respective tier or does not have a semantically similar query in the sematic cluster associated with the respective tier, then an LLM may be called to generate a response to the incoming query, as discussed further below in conjunction with FIG. 4.

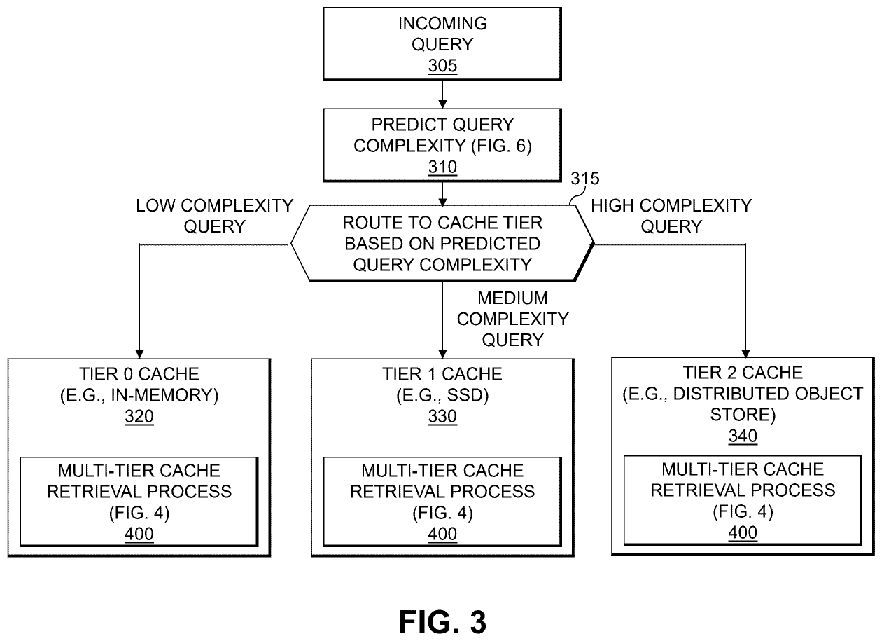

FIG. 3 is a flow diagram illustrating an exemplary implementation of a process for multi-tier caching of language model queries in accordance with an illustrative embodiment. In the example of FIG. 3, a query complexity of an incoming query 305 is predicted in step 310, as discussed further below in conjunction with FIG. 6. The incoming query 305 is routed to a given cache tier in step 315 based on the predicted query complexity. If the incoming query 305 is classified as a low complexity query (e.g., using the complexity thresholds of FIG. 2), the incoming query 305 is routed to the tier 0 cache (e.g., an in-memory cache) 320. If the incoming query 305 is classified as a medium complexity query, the incoming query 305 is routed to the tier 1 cache (e.g., an SSD cache) 330. If the incoming query 305 is classified as a high complexity query, the incoming query 305 is routed to the tier 2 cache (e.g., a distributed object store cache) 340.

Following the routing of the incoming query 305 to the designated cache tier, a multi-tier cache retrieval process 400 is initiated with respect to the designated cache tier, as discussed further below in conjunction with FIG. 4.

FIG. 4 is a flow diagram illustrating an exemplary implementation of a multi-tier cache retrieval process 400 in accordance with an illustrative embodiment. The multi-tier cache retrieval process 400, in at least some embodiments, may be performed by the adaptive multi-tier caching engine 105 of FIG. 1, or portions thereof. For example, the multi-tier query/response cache 118 may orchestrate the process of FIG. 4 with assistance from the semantic query clustering module 122 for semantic similarity lookups. In the example of FIG. 4, an incoming query 305 that was routed to a designated cache tier (e.g., routed based at least in part on the query complexity score in step 315) is received in the designated cache tier in step 405.

A test is performed in step 415 to determine if the incoming query matches a query that is cached in the designated cache tier. If it is determined in step 415 that the incoming query matches a query cached in the designated cache tier, then the cached response is served to the user in step 420. The matching evaluation of step 415 may comprise an exact match comparison by performing a lookup in the designated cache tier using a query-dependent value of the incoming query. As used herein, the term “query-dependent value” shall be broadly construed to encompass, for example, hash values and other query representations, such as string normalization, canonicalization and/or fingerprinting that achieve functionally equivalent exact-matching behavior, as would be apparent to a person of ordinary skill in the art. If, however, it is determined in step 415 that the incoming query does not match a query cached in the designated cache tier, then a look up is performed in a semantic cluster associated with the designated cache tier in step 425. The lookup of step 425, in at least some embodiments, comprises a semantic similarity search that employs a cosine similarity evaluation of vector embeddings of the incoming query, relative to vector embeddings of queries in the tier-specific semantic cluster. For example, the cosine similarity evaluation may comprise determining whether a semantic similarity score of the incoming query exceeds a semantic similarity threshold (θ). The semantic similarity threshold (θ) may be dynamically adjusted, in some embodiments, by the RL agent 116, as discussed below.

As discussed further below in conjunction with FIG. 7, the semantic clusters are tier-specific, where each cache tier (e.g., the tier 0 cache, the tier 1 cache and the tier 2 cache) maintains its own local set of semantic clusters that reflect the nature and density of queries handled in the respective cache tier (thereby ensuring that the semantic clustering operates with tier-appropriate thresholds and historical context). Generally, in the example of FIG. 7, the tier-specific semantic clusters are dynamically formed within each tier by applying incremental HDBSCAN (Hierarchical Density-Based Spatial Clustering of Applications with Noise) to embeddings of previously seen queries. Importantly, in the example of FIG. 4, the semantic similarity check (e.g., steps 425 and 430) is local to the respective cache tier, preserving both performance alignment and architectural modularity. For example, the tier 0 cache may cluster simpler, high-frequency queries, while the tier 2 cache may handle complex, sparsely occurring queries. In this manner, the accuracy in reuse decisions is improved by aligning cluster semantics with a query profile of each respective caching tier.

The cosine similarity evaluation of step 425 may be expressed, for example, as follows:

$$S ( Q , {Q}^{′} ) = \frac{e ( Q ) e ( {Q}^{′} )}{‖ e ( Q ) ‖ ‖ e ( {Q}^{′} ) ‖} ,$$

where a similarity threshold et for the similarity evaluation may be adapted by the RL agent 116. The query embeddings may be expressed as E∈ [symbol] ^{d}. A test is performed in step 430 to determine if the incoming query has a similarity score with respect to a query in the semantic cluster associated with the designated cache tier that satisfies one or more designated similarity criteria. The one or more designated similarity criteria may comprise comparing the similarity score to one or more semantic similarity thresholds (0). The semantic similarity thresholds (0) may be centrally managed, in at least some embodiments, and dynamically adjusted by the RL agent 116. Thus, the different tiers of the multi-tier query/response cache 118 may apply the same semantic matching mechanism (e.g., query embeddings, semantic clustering, such as HDBSCAN, and a cosine similarity evaluation), but the similarity thresholds may differ for each tier of the multi-tier query/response cache 118 (e.g., based on tier utilization and/or cluster density). The different similarity thresholds for each tier of the multi-tier query/response cache 118 may be denoted as θ₀, θ₁, θ₂.

If it is determined in step 430 that the incoming query has a similarity score with respect to a query in the semantic cluster associated with the designated cache tier that satisfies one or more designated similarity criteria, then the cached response is served to the user in step 435. In this manner, if the semantic similarity exceeds the applicable semantic similarity threshold (θ), the adaptive multi-tier caching engine 105 reuses the cached result from the respective semantic cluster.

If, however, it is determined in step 430 that the incoming query does not have a similarity score with respect to a query in the semantic cluster that satisfies the one or more designated similarity criteria, then at least one LLM is called in step 440 to generate a response. The query response from the at least one language model is provided to a query prediction engine (e.g., the query prediction module 112) in step 450, as discussed further below in conjunction with FIG. 5.

FIG. 5 illustrates a processing of queries predicted by a query prediction engine in accordance with an illustrative embodiment. In the example of FIG. 5, query responses from LLMs (e.g., generated in FIG. 4) are applied to a query prediction engine 510 that analyzes historical query data to (e.g., proactively) predict likely future queries, referred to in FIG. 5 as predicted queries 515, as discussed further below in conjunction with FIG. 8. Generally, the query prediction engine 510 preemptively caches queries that are likely to be seen again in a predicted query cache 530 (e.g., tier 2 cache of the multi-tier query/response cache 118, by default), in advance, to reduce latency and improve response times. As the predicted queries 515 comprise asynchronous, high-complexity anticipations, where latency may be less critical, long-term storage in the distributed tier 2 cache of the multi-tier query/response cache 118 may be preferred.

In one or more embodiments, a feedback loop 535 from the predicted query cache 530 back to query prediction engine 510, for example, to allow the query prediction engine 510 to learn from the predicted queries 515 that are reused (e.g., retrieved from the predicted query cache 530 in response to a similar new incoming query). The feedback loop 535 improves a Poisson-Gaussian prediction model that forecasts probabilities of query reuse, λ(Q,T), as discussed further below in conjunction with FIG. 8. While such learning may be performed asynchronously or periodically, the learning is important for closing the loop between prediction and caching effectiveness. In this manner, the cache hit history of predicted queries 515 from the predicted query cache 530 informs the future prediction logic.

An RL-based cache tier resizing engine 520 dynamically adjusts a size of each cache tier, as discussed further below in conjunction with FIG. 9. Generally, the RL-based cache tier resizing engine 520 may dynamically adjust the size of one or more of the cache tiers based on, for example, recent cache hit/cache miss rates and/or tier utilization. For example, the distributed tier 2 cache may be expanded if many predicted queries 515 are queued, or may be reduced during times of low query reuse probability. Among other functions, the RL-based cache tier resizing engine 520 may override the default storage of the predicted queries 515 in the distributed tier 2 cache by shifting high-probability predictions to the tier 1 cache, if needed or desired.

In some embodiments, the RL agent 116 may be logically centralized but functionally tier-aware. The RL agent 116 may execute within the RL-based cache tier resizing engine 520 of FIG. 5. The RL agent 116 may monitor cache utilization metrics, cache hit and/or cache miss rates and semantic density across the cache tiers. In addition, the RL agent 116 may dynamically adjust a size of each cache tier, as well as the semantic similarity thresholds (θ) used in step 430 of FIG. 4. The centralized execution of the RL agent 116 ensures cross-tier optimization while respecting tier-local behavior, such as cluster matching and/or proactive prediction feedback.

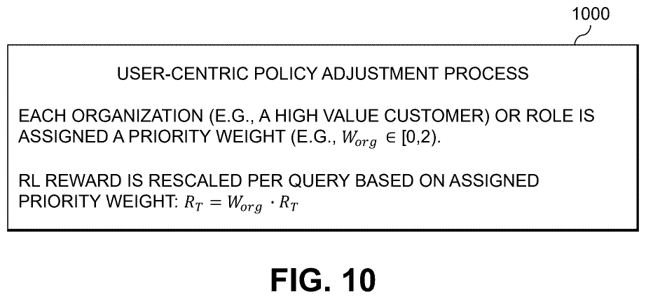

A user-centric policy adjustment engine 540 influences a caching strategy based on, for example, user feedback (e.g., organization, user role and/or user-specific weights to prioritize certain users, such as business-critical users), as discussed further below in conjunction with FIG. 10. In this manner, users or user roles can provide feedback that influences the caching strategies. For example, users who frequently query specific data can have their preferences prioritized in the caching strategy.

In some embodiments, the user-centric policy adjustment engine 540 may bias the routing of predictions using assigned priority weights (W_{org}). Thus, predicted queries 515 from high-priority users may be stored in higher-tier caches (e.g., the tier 1 cache or even the tier 0 cache) for faster future access. These mechanisms allow the adaptive multi-tier caching engine 105 to treat predicted queries 515 with nuance.

FIG. 6 is a process diagram illustrating an exemplary implementation of a query complexity prediction process 600 in accordance with an illustrative embodiment. In the example of FIG. 6, the query complexity prediction process 600 initially obtains a feature vector, X(Q), for incoming query. A representative feature vector, X(Q), may be expressed, as follows:

$$X ( Q ) = [ token count , parse tree depth , historical latency , 1 - max S ( e ( q ) , e ( {q}_{j}^{freq} ) ) ] .$$

The query complexity prediction process 600 then computes a query complexity, K(Q), for the incoming query, as follows:

K(Q)=σ(w^{T}·X(Q)+b),

where σ is a logistic function, w^{T} is a transposed weight vector of learned model parameters and b is a bias term. In at least some embodiments, the transposed weight vector w^{T} represents a transpose of a learned weight vector, typically derived during the training phase of a linear classifier or probe (such as logistic regression). The transposed weight vector w^{T} aligns dimensionally with the query feature vector, X(Q), allowing a dot product to compute a weighted sum of the features. The bias term b (e.g., a scalar bias) allows the model to shift the decision boundary independently of the weighted inputs, enabling more flexible separation when classifying queries as low, medium, or high complexity, for example. The model may be used to produce a scalar complexity score K(Q) between a value of 0 and 1, for example, via the logistic function σ, which can then be bucketed (e.g., discretized) into discrete complexity levels (e.g., K<0.33−>L0, etc.). This formulation may be considered lightweight, interpretable and suitable for online learning and fast inference, which is important for low-latency, real-time systems, such as the disclosed multi-tier cache architecture.

FIG. 7 is a process diagram illustrating an exemplary implementation of a semantic query clustering process 700 in accordance with an illustrative embodiment. As noted above, in the example of FIG. 7, the tier-specific semantic clusters are dynamically formed within each tier by applying incremental clustering, such as HDBSCAN, to embeddings of previously seen queries.

In some embodiments, semantically related queries are grouped together within the multi-tier cache, reducing redundant processing and speeding up the retrieval of similar queries by reusing previous results. For example, semantic clustering reduces (e.g., minimizes) duplicate query processing, allowing similar queries to reuse previously computed responses (thereby reducing the load on AI models and improving response times).

The incremental clustering algorithm (such as an HDBSCAN) is initially applied to embeddings for previous queries in each cache tier. Thus, each tier in the multi-tier query/response cache 118 may generate and maintain its own semantic clusters. This tier-locality may ensure that the clustering reflects query patterns and semantic density per tier, helping to manage storage constraints and allow query result reuse even in deep cache tiers, such as the tier 2 cache.

The semantic clustering may employ a merge rule in some embodiments, whereby a new query is added to a cluster having a radius that maximizes an average similarity (otherwise, the new query is added to a new cluster). The generated semantic clusters may be employed, for example, in step 425 of FIG. 4, as part of the semantic cluster lookup. The semantic clusters may be incrementally updated, in some embodiments, and each cache tier can maintain its own embeddings and cluster centroids.

FIG. 8 is a process diagram illustrating an exemplary implementation of a query prediction process 800 in accordance with an illustrative embodiment. In the example of FIG. 8, a Poisson-Gaussian process is fit on time-series counts for each cluster (e.g., a predicted query frequency for a cluster Q, at future time T+4), as follows:

$${\hat{N}}_{T + Δ} ( {Q}_{c} ) = α {N}_{T} ( {Q}_{c} ) + ( 1 - α ) ( μ {U}_{{Q}_{c}} + ϕ sin \frac{2 π T}{P} ) ,$$

where N_{T} (Q_{c}) comprises an observed count for cluster Qc at time T, weighted by a weighting factor α, μU_{Q}_{_{c}} is a long-term query rate (e.g., a global mean for the respective semantic cluster) and φ and P comprise an amplitude and period of the seasonal component, respectively. The probability of reuse (e.g., that a given query will be repeated) may be expressed, as follows:

λ(Q,T)=1−exp(−\hat{N}_{T+Δ}(Q_{c})

Entries with λ≥λ_{MIN} may be pre-generated and cached in the L2 cache to preemptively generate and cache responses based on a predicted query recurrence. In this manner, queries may be preemptively selected (e.g., based on λ(Q,T)), pre-answered using the LLM, and stored asynchronously in the tier 2 cache, for example. In this manner, latency (e.g., user wait time) and LLM spikes are reduced. Thus, in one or more embodiments, an LLM may be used in a reactive mode (e.g., as discussed above in conjunction with FIG. 4) and in a proactive mode (e.g., as discussed in conjunction with FIG. 8). The similarity threshold AMIN for the similarity evaluation may be adapted by the RL agent 116.

FIG. 9 is a process diagram illustrating an exemplary implementation of an RL-based cache partitioning process 900 in accordance with an illustrative embodiment. In the example of FIG. 9, the RL state, S (T), may be expressed, as follows:

S(T)=(u₀,u₁,u₂,HR,Θ_{T},λₘᵢₙ),

where uᵢ indicates the utilization ratio of a given tier; HR indicates the cache hit rate (e.g., in the last interval), Θ_{T}, is a current similarity threshold and λₘᵢₙ is a predicted reuse rate.

The available RL actions, a_{T}, may be expressed, as follows:

a_{T}∈(±δu₀,±δu₁,±δu₂,±δΘ,±δλ),

where δ indicates a bounded adjustment to one or more of the utilization metrics for each tier of the multi-tier cache or one of the thresholds (Θ_{T},λₘᵢₙ). The thresholds (Θ_{T},λₘᵢₙ) may be updated every RL cycle, for example, as follows:

$${Θ}_{T + 1} = {Θ}_{T} + {η}_{Θ} δΘ ,$$

$$and$$

$${λ}_{min}^{T + 1} = {λ}_{min}^{T} + {η}_{λ} δλ ,$$

where δΘ and δλ are the chosen actions and n_{Θ} and n_{λ} are per-parameter step sizes constrained so that 0.5≤Θ≤0.90 and 0.01≤λₘᵢₙ≤0.5.

The RL reward, RT, may be expressed, as follows:

$${R}_{T} = α ( {HR}_{T} - {HR}_{T - 1} ) - {β ( \frac{LLM CALLS}{QUERIES} )}_{T} - γ CLOUD STORAGE {COST}_{T} ,$$

where α, β and γ comprise learned coefficients that balance cache hit rate, LLM call minimization and/or cloud cost, for example.

The RL agent 116 may be trained in some embodiments using Double Q-learning techniques (e.g., Double DQN). Double Q-learning provides stability in training, for example, compared to standard Q-learning, which is beneficial given the dynamic resizing of the multiple cache tiers.

FIG. 10 is a process diagram illustrating an exemplary implementation of a user-centric policy adjustment process 1000 in accordance with an illustrative embodiment. In the example of FIG. 10, each organization (e.g., an enterprise) or user role defines a priority weight, as follows:

W_{org}∈[0,2),

where the notation [0, 2) indicates a mathematical interval comprising real numbers greater than or equal to 0 (e.g., no priority) and less than 2 (e.g., highest priority). W_{org} modulates the RL reward for each query. W_{org} values above 1 boost the reward, for example, to favor the corresponding user or organization; and values below 1 tend to deprioritize the corresponding user or organization. The W_{org} weight may be configurable in some embodiments, per organization or user role and may be dynamically tunable based on business needs.

The reward, RT, may be rescaled for each query based on the assigned organization priority weight, as follows:

R_{T}=W_{org}·R_{T}.

Thus, for organizations or users (e.g., high-value customers) that are assigned a higher priority weight, the multi-tier cache naturally allocates more resources (e.g., RAM) to their workloads without manual rules. Thus, such user-centric policies bias the RL reward so that organizations or users having a higher priority weight get priority (sometimes referred to as role-aware reward shaping).

For example, when a given query, such as “Product A RAM specification,” having a low complexity score, is first received, the multi-tier cache (e.g., the L0 cache) will not have seen the query previously, so a cache miss will be encountered. In some embodiments, an LLM will be called to generate an answer (e.g., in step 440 of FIG. 4). The reward will be at a baseline. If 200 similar specification queries are then received two minutes later, there will be a cache hit in the L0 cache (increasing the cache hit rate and having an associated positive reward). If a surge in queries is then detected, for example, associated with a new product launch (such as queries of the form “Product B configuration” (having a medium complexity score), the L1 tier cache will fill and the RL agent 116 may raise the L1 cache allocation (e.g., shifting 1 GB from the L0 cache to the L1 cache) and lower the θ threshold, resulting in the L1 cache being stable. If a few bespoke queries related to migration plans (and having high complexity score) are predicted, the pre-generated responses will be stored in the L2 cache, avoiding an LLM load.

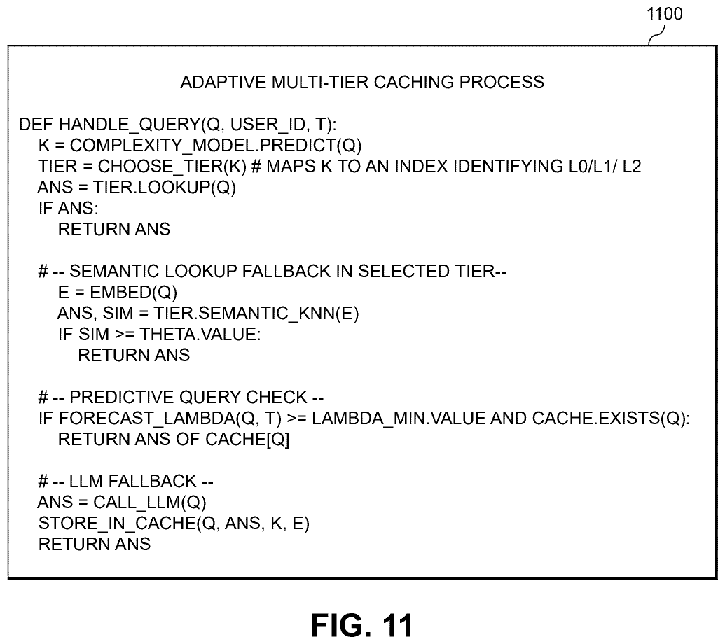

FIG. 11 is a process diagram illustrating an exemplary implementation of an adaptive multi-tier caching process 1100 in accordance with an illustrative embodiment. In the example of FIG. 11, a complexity score, K(Q), for an incoming query, Q, is evaluated to select a cache tier. For example, the complexity score, K(Q), may be mapped to an index that identifies a selected cache tier (e.g., L0/L1/L2). The selected cache tier determines if the incoming query matches a query cached in the selected cache tier (e.g., by evaluating a query-dependent value, such as a hash value, of the incoming query compared to queries cached in the selected cache tier). Thus, the first portion of the adaptive multi-tier caching process 1100 performs an exact match lookup in the selected cache tier and returns the corresponding prior response if a match is found.

In the event that an exact match is not found in the selected cache tier, a semantic lookup fallback operation is performed in the selected cache tier to determine if the incoming query has a semantic similarity score, with respect to one or more queries in at least one sematic cluster associated with the selected cache tier, that satisfies one or more designated similarity criteria. The semantic similarity evaluation may employ a K-nearest neighbor (KNN) similarity or a cosine similarity evaluation of vector embeddings of the incoming query, relative to vector embeddings of queries in the semantic cluster associated with the selected cache tier. For example, the cosine similarity evaluation may comprise determining whether a semantic similarity score of the incoming query exceeds a semantic similarity threshold (θ). The semantic lookup fallback operation returns the corresponding prior response if a semantic match is found in the sematic cluster associated with the selected cache tier.

In the event that the incoming query does not match a query cached in the selected cache tier or does not have a semantically similar query in the sematic cluster associated with the selected cache tier, then a predictive query check operation determines if the incoming query is similar to a predicted query 515 stored in the multi-tier cache. Predicted queries 515 may be primarily pre-cached in the tier two cache, as the predicted queries 515 are often high-complexity and less latency-sensitive. However, the RL agent 116 can relocate high-confidence, high-priority predicted queries to upper tiers (e.g., the tier zero cache and/or the tier one cache).

As shown in FIG. 11, if (i)λ(Q, T)≥λₘᵢₙ and (ii) the incoming query exists in the multi-tier cache, then the predictive query check operation returns the corresponding predicted response stored in the multi-tier cache.

In the event that the incoming query does not match a query cached in the selected cache tier or does not have a semantically similar query in the sematic cluster associated with the selected cache tier or in the predicted queries 515, then an LLM may be called (e.g., by an LLM fallback operation) to generate a response to the incoming query, as discussed herein.

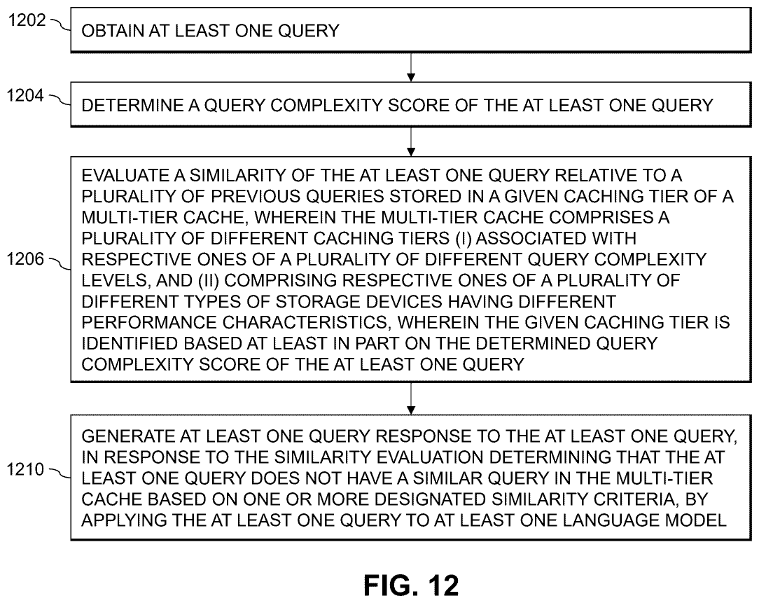

FIG. 12 is a flow diagram illustrating an exemplary implementation of a process for multi-tier caching of language model queries in accordance with an illustrative embodiment. In the example of FIG. 12, at least one query is obtained in step 1202. A query complexity score of the at least one query is determined in step 1204. In step 1206, a similarity of the at least one query is evaluated relative to a plurality of previous queries stored in a given caching tier of a multi-tier cache, wherein the multi-tier cache comprises a plurality of different caching tiers (i) associated with respective ones of a plurality of different query complexity levels, and (ii) comprising respective ones of a plurality of different types of storage devices having different performance characteristics, wherein the given caching tier is identified based at least in part on the determined query complexity score of the at least one query.

The term “cache,” as used herein, shall be broadly construed to encompass any processor-readable storage media including, without limitation, a storage array, a storage drive, including SSDs, or an integrated circuit comprising RAM, ROM or other electronic memory, or combinations thereof, in any configuration, including caches having multiple tiers and/or multiple levels, as well as distributed caches, or any of a wide variety of other types of storage products, as would be apparent to a person of ordinary skill in the art.

At least one query response to the at least one query is generated in step 1210, in response to the similarity evaluation determining that the at least one query does not have a similar query in the multi-tier cache based on one or more designated similarity criteria, by applying the at least one query to at least one language model.

In one or more embodiments, the plurality of different types of storage devices having different performance characteristics comprises an in-memory storage device type, a solid-state drive storage device type and a distributed object store storage device type. The plurality of different caching tiers may have an associated complexity score range, and wherein the at least one query is assigned to a given one of the plurality of different caching tiers of the multi-tier cache based at least in part on the determined query complexity score.

In some embodiments, the plurality of previous queries stored in the given caching tier of the multi-tier cache comprises a first plurality of previous queries cached in the given caching tier and a second plurality of previous queries stored in one or more semantic clusters associated with the given caching tier. In addition, a similarity of the at least one query may be evaluated with respect to the first plurality of previous queries cached in the given caching tier by performing a lookup in the given caching tier using a query-dependent value, and, in response to the lookup determining that the at least one query matches a given one of the first plurality of previous queries cached in the given caching tier of the multi-tier cache, generating at least one query response to the at least one query by processing a query response associated with the given previous query. A similarity of the at least one query may be evaluated with respect to the second plurality of previous queries stored in one or more semantic clusters associated with the given caching tier by performing a semantic lookup in the one or more semantic clusters, and, in response to the semantic lookup determining that the at least one query has a similarity score with respect to a given previous query in the one or more semantic clusters that satisfies one or more designated similarity criteria, generating at least one query response to the at least one query by processing a query response associated with the given previous query.

In at least one embodiment, the process of FIG. 12 may further comprise applying the at least one query response to a processor-based query predictor that identifies the at least one query as a predicted query based at least in part on a determined query reuse probability score of the at least one query and stores the at least one query response in at least one tier of the multi-tier cache. The process of FIG. 12 may further comprise performing at least one action with respect to the multi-tier cache, wherein the at least one action is selected, at least in part, by at least one processor-based reinforcement learning model that evaluates (i) a state comprising one or more of a utilization metric for each tier of the multi-tier cache, a cache hit rate ratio and at least one threshold for evaluating a similarity metric and a predicted reuse rate, and (ii) a reward based at least in part on one or more of a change in the cache hit rate ratio, a ratio of a number of language model calls to a total number of queries and a storage cost for at least one of the caching tiers of the multi-tier cache, wherein the at least one action comprises one or more of an adjustment to one or more of the utilization metric for one or more of the caching tiers of the multi-tier cache and the at least one threshold. The reward may be scaled based at least in part on a weight assigned to one or more of an organization and a user role.

The particular processing operations and other network functionality described in conjunction with FIGS. 2 through 4 and 6 through 12, for example, are presented by way of illustrative example only, and should not be construed as limiting the scope of the disclosure in any way. Alternative embodiments can use other types of processing operations for multi-tier caching of language model queries. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

Among other benefits, the disclosed multi-tier caching techniques exhibit improved response times. By predicting query complexity and clustering related queries, the multi-tier caching system encourages fast and accurate responses to both simple and complex queries. In addition, adaptive cache partitioning techniques dynamically reallocate resources to frequently accessed tiers, helping to ensure that cache space is not wasted and optimally used. The semantic clustering techniques reduce the number of duplicate LLM calls for similar queries, thereby improving system efficiency and saving computational resources. The user-centric caching policies allow the multi-tier cache system to adapt to individual user needs, further improving response times for personalized tasks.

In a customer support system, for example, common questions (such as “What is my account balance?”) are classified as low-complexity and may be stored in the tier 0 cache for prompt retrieval. More complex queries, such as “Can you recommend an investment strategy based on my portfolio?,” are semantically clustered with other related queries and stored in the tier 2 cache. The system adapts dynamically to usage patterns. For example, during peak hours, the multi-tier cache system expands the tier 0 cache for fast processing of frequently asked questions, while during quieter times, the multi-tier cache system reduces in-memory usage of the tier 0 cache and focuses on deeper cache tiers.

It can be shown that the disclosed multi-tier caching techniques exhibit a 74% cache hit rate, significantly fewer (e.g., approximately 90% fewer) LLM calls and a faster response time (e.g., approximately 20 ms) for repeated queries.

One or more embodiments of the disclosure provide improved methods, apparatus and computer program products for multi-tier caching of language model queries. The foregoing applications and associated embodiments should be considered as illustrative only, and numerous other embodiments can be configured using the techniques disclosed herein, in a wide variety of different applications.

It should also be understood that the disclosed techniques for multi-tier caching of language model queries, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for multi-tier caching of language model queries may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a Platform-as-a-Service (PaaS) model, an Infrastructure-as-a-Service (IaaS) model, a Storage-as-a-Service (STaaS) model and/or a Function-as-a-Service (FaaS) model, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based multi-tier caching engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based multi-tier caching platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

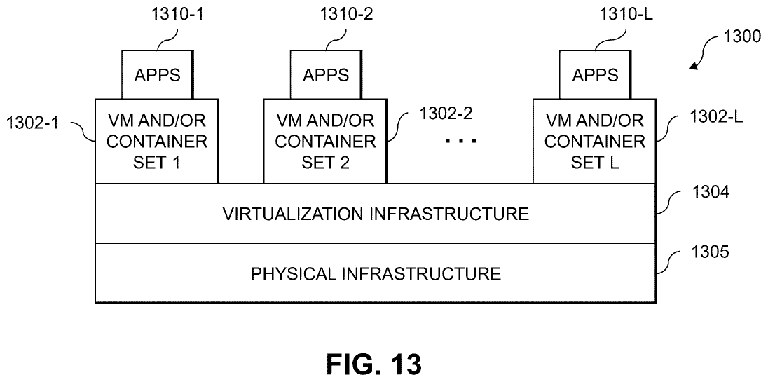

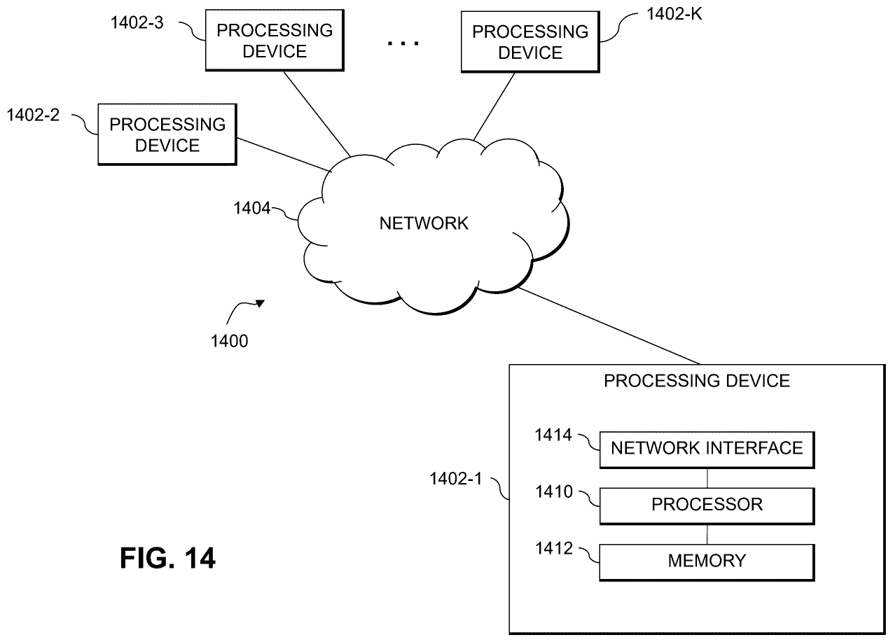

Illustrative embodiments of processing platforms will now be described in greater detail with reference to FIGS. 13 and 14. These platforms may also be used to implement at least portions of other information processing systems in other embodiments.

FIG. 13 shows an example processing platform comprising cloud infrastructure 1300. The cloud infrastructure 1300 comprises a combination of physical and virtual processing resources that may be utilized to implement at least a portion of the information processing system 100. The cloud infrastructure 1300 comprises multiple virtual machines (VMs) and/or container sets 1302-1, 1302-2, . . . 1302-L implemented using virtualization infrastructure 1304. The virtualization infrastructure 1304 runs on physical infrastructure 1305, and illustratively comprises one or more hypervisors and/or operating system level virtualization infrastructure. The operating system level virtualization infrastructure illustratively comprises kernel control groups of a Linux operating system or other type of operating system.

The cloud infrastructure 1300 further comprises sets of applications 1310-1, 1310-2, . . . 1310-L running on respective ones of the VMs/container sets 1302-1, 1302-2, . . . 1302-L under the control of the virtualization infrastructure 1304. The VMs/container sets 1302 may comprise respective VMs, respective sets of one or more containers, or respective sets of one or more containers running in VMs.

In some implementations of the FIG. 13 embodiment, the VMs/container sets 1302 comprise respective VMs implemented using virtualization infrastructure 1304 that comprises at least one hypervisor. Such implementations can provide multi-tier caching functionality of the type described above for one or more processes running on a given one of the VMs. For example, each of the VMs can implement control logic for multi-tier caching and associated functionality for generating query responses using at least one language model, when needed.

An example of a hypervisor platform that may be used to implement a hypervisor within the virtualization infrastructure 1304 is a compute virtualization platform which may have an associated virtual infrastructure management system such as server management software. The underlying physical machines may comprise one or more distributed processing platforms that include one or more storage systems.

In other implementations of the FIG. 13 embodiment, the VMs/container sets 1302 comprise respective containers implemented using virtualization infrastructure 1304 that provides operating system level virtualization functionality, such as support for Docker containers running on bare metal hosts, or Docker containers running on VMs. The containers are illustratively implemented using respective kernel control groups of the operating system. Such implementations can provide multi-tier caching functionality of the type described above for one or more processes running on different ones of the containers. For example, a container host device supporting multiple containers of one or more container sets can implement one or more instances of control logic for multi-tier caching and associated functionality for generating query responses using at least one language model, when needed.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1300 shown in FIG. 13 may represent at least a portion of one processing platform. Another example of such a processing platform is processing platform 1400 shown in FIG. 14.

The processing platform 1400 in this embodiment comprises at least a portion of the given system and includes a plurality of processing devices, denoted 1402-1, 1402-2, 1402-3, . . . 1402-K, which communicate with one another over a network 1404. The network 1404 may comprise any type of network, such as a WAN, a LAN, a satellite network, a telephone or cable network, a cellular network, a wireless network such as WiFi or WiMAX, or various portions or combinations of these and other types of networks.

The processing device 1402-1 in the processing platform 1400 comprises a processor 1410 coupled to a memory 1412. The processor 1410 may comprise a microprocessor, a microcontroller, an ASIC, an FPGA, a CPU, a GPU, a TPU, a VPU, an NPU, a DPU, an SOC or other type of processing circuitry, as well as portions or combinations of such circuitry elements, and the memory 1412, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage drive or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1402-1 is network interface circuitry 1414, which is used to interface the processing device with the network 1404 and other system components, and may comprise conventional transceivers.

The other processing devices 1402 of the processing platform 1400 are assumed to be configured in a manner similar to that shown for processing device 1402-1 in the figure.

Again, the particular processing platform 1400 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 13 or 14, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

1. A method, comprising:
obtaining at least one query;
determining a query complexity score of the at least one query, wherein the query complexity score characterizes a complexity of the at least one query;
evaluating a similarity of the at least one query relative to a plurality of previous queries stored in a given caching tier of a multi-tier cache, wherein the multi-tier cache comprises a plurality of different caching tiers (i) associated with respective ones of a plurality of different query complexity levels, and (ii) comprising respective ones of a plurality of different types of storage devices having different performance characteristics, wherein the given caching tier is identified based at least in part on the determined query complexity score of the at least one query; and
generating at least one query response to the at least one query, in response to the similarity evaluation determining that the at least one query does not have a similar query in the multi-tier cache based on one or more designated similarity criteria, by applying the at least one query to at least one language model;
wherein the method is performed by at least one processing device comprising a processor coupled to a memory.

2. The method of claim 1, wherein the plurality of different types of storage devices having different performance characteristics comprises an in-memory storage device type, a solid-state drive storage device type and a distributed object store storage device type.

3. The method of claim 1, wherein the plurality of previous queries stored in the given caching tier of the multi-tier cache comprises a first plurality of previous queries cached in the given caching tier and a second plurality of previous queries stored in one or more semantic clusters associated with the given caching tier.

4. The method of claim 3, further comprising evaluating a similarity of the at least one query with respect to the first plurality of previous queries cached in the given caching tier by performing a lookup in the given caching tier using a query-dependent value, and, in response to the lookup determining that the at least one query matches a given one of the first plurality of previous queries cached in the given caching tier of the multi-tier cache, generating at least one query response to the at least one query by processing a query response associated with the given previous query.

5. The method of claim 4, further comprising evaluating a similarity of the at least one query with respect to the second plurality of previous queries stored in the one or more semantic clusters associated with the given caching tier by performing a semantic lookup in the one or more semantic clusters, and, in response to the semantic lookup determining that the at least one query has a similarity score with respect to a given previous query in the one or more semantic clusters that satisfies one or more of the designated similarity criteria, generating at least one query response to the at least one query by processing a query response associated with the given previous query.

6. The method of claim 1, further comprising applying the at least one query response to a processor-based query predictor that identifies the at least one query as a predicted query based at least in part on a determined query reuse probability score of the at least one query and stores the at least one query response in at least one tier of the multi-tier cache, prior to the obtaining the at least one query.

7. The method of claim 1, further comprising performing at least one action with respect to the multi-tier cache, wherein the at least one action is selected, at least in part, by at least one processor-based reinforcement learning model that evaluates (i) a state comprising one or more of a utilization metric for each tier of the multi-tier cache, a cache hit rate ratio of the multi-tier cache and at least one threshold for evaluating one or more of a similarity metric and a predicted reuse rate, and (ii) a reward based at least in part on one or more of a change in the cache hit rate ratio, a ratio of a number of language model calls to a total number of queries and a storage cost for at least one of the caching tiers of the multi-tier cache, wherein the at least one action comprises one or more of an adjustment to one or more of the utilization metric for one or more of the caching tiers of the multi-tier cache and the at least one threshold.

8. The method of claim 7, further comprising scaling the reward based at least in part on a weight assigned to one or more of an organization and a user role.

9. An apparatus comprising:
at least one processing device comprising a processor coupled to a memory;
the at least one processing device being configured to implement the following steps:
obtaining at least one query;
determining a query complexity score of the at least one query, wherein the query complexity score characterizes a complexity of the at least one query;
evaluating a similarity of the at least one query relative to a plurality of previous queries stored in a given caching tier of a multi-tier cache, wherein the multi-tier cache comprises a plurality of different caching tiers (i) associated with respective ones of a plurality of different query complexity levels, and (ii) comprising respective ones of a plurality of different types of storage devices having different performance characteristics, wherein the given caching tier is identified based at least in part on the determined query complexity score of the at least one query; and
generating at least one query response to the at least one query, in response to the similarity evaluation determining that the at least one query does not have a similar query in the multi-tier cache based on one or more designated similarity criteria, by applying the at least one query to at least one language model.

10. The apparatus of claim 9, wherein the plurality of previous queries stored in the given caching tier of the multi-tier cache comprises a first plurality of previous queries cached in the given caching tier and a second plurality of previous queries stored in one or more semantic clusters associated with the given caching tier.

11. The apparatus of claim 10, further comprising one or more of: (i) evaluating a similarity of the at least one query with respect to the first plurality of previous queries cached in the given caching tier by performing a lookup in the given caching tier using a query-dependent value, and, in response to the lookup determining that the at least one query matches a given one of the first plurality of previous queries cached in the given caching tier of the multi-tier cache, generating at least one query response to the at least one query by processing a query response associated with the given previous query; and (ii) evaluating a similarity of the at least one query with respect to the second plurality of previous queries stored in the one or more semantic clusters associated with the given caching tier by performing a semantic lookup in the one or more semantic clusters, and, in response to the semantic lookup determining that the at least one query has a similarity score with respect to a given previous query in the one or more semantic clusters that satisfies one or more of the designated similarity criteria, generating at least one query response to the at least one query by processing a query response associated with the given previous query.

12. The apparatus of claim 9, further comprising applying the at least one query response to a processor-based query predictor that identifies the at least one query as a predicted query based at least in part on a determined query reuse probability score of the at least one query and stores the at least one query response in at least one tier of the multi-tier cache, prior to the obtaining the at least one query.

13. The apparatus of claim 9, further comprising performing at least one action with respect to the multi-tier cache, wherein the at least one action is selected, at least in part, by at least one processor-based reinforcement learning model that evaluates (i) a state comprising one or more of a utilization metric for each tier of the multi-tier cache, a cache hit rate ratio of the multi-tier cache and at least one threshold for evaluating one or more of a similarity metric and a predicted reuse rate, and (ii) a reward based at least in part on one or more of a change in the cache hit rate ratio, a ratio of a number of language model calls to a total number of queries and a storage cost for at least one of the caching tiers of the multi-tier cache, wherein the at least one action comprises one or more of an adjustment to one or more of the utilization metric for one or more of the caching tiers of the multi-tier cache and the at least one threshold.

14. The apparatus of claim 13, further comprising scaling the reward based at least in part on a weight assigned to one or more of an organization and a user role.

15. A non-transitory processor-readable storage medium having stored therein program code of one or more software programs, wherein the program code when executed by at least one processing device causes the at least one processing device to perform the following steps:
obtaining at least one query;
determining a query complexity score of the at least one query, wherein the query complexity score characterizes a complexity of the at least one query;
evaluating a similarity of the at least one query relative to a plurality of previous queries stored in a given caching tier of a multi-tier cache, wherein the multi-tier cache comprises a plurality of different caching tiers (i) associated with respective ones of a plurality of different query complexity levels, and (ii) comprising respective ones of a plurality of different types of storage devices having different performance characteristics, wherein the given caching tier is identified based at least in part on the determined query complexity score of the at least one query; and
generating at least one query response to the at least one query, in response to the similarity evaluation determining that the at least one query does not have a similar query in the multi-tier cache based on one or more designated similarity criteria, by applying the at least one query to at least one language model.

16. The non-transitory processor-readable storage medium of claim 15, wherein the plurality of previous queries stored in the given caching tier of the multi-tier cache comprises a first plurality of previous queries cached in the given caching tier and a second plurality of previous queries stored in one or more semantic clusters associated with the given caching tier.

17. The non-transitory processor-readable storage medium of claim 16, further comprising one or more of: (i) evaluating a similarity of the at least one query with respect to the first plurality of previous queries cached in the given caching tier by performing a lookup in the given caching tier using a query-dependent value, and, in response to the lookup determining that the at least one query matches a given one of the first plurality of previous queries cached in the given caching tier of the multi-tier cache, generating at least one query response to the at least one query by processing a query response associated with the given previous query; and (ii) evaluating a similarity of the at least one query with respect to the second plurality of previous queries stored in the one or more semantic clusters associated with the given caching tier by performing a semantic lookup in the one or more semantic clusters, and, in response to the semantic lookup determining that the at least one query has a similarity score with respect to a given previous query in the one or more semantic clusters that satisfies one or more of the designated similarity criteria, generating at least one query response to the at least one query by processing a query response associated with the given previous query.

18. The non-transitory processor-readable storage medium of claim 15, further comprising applying the at least one query response to a processor-based query predictor that identifies the at least one query as a predicted query based at least in part on a determined query reuse probability score of the at least one query and stores the at least one query response in at least one tier of the multi-tier cache, prior to the obtaining the at least one query.

19. The non-transitory processor-readable storage medium of claim 15, further comprising performing at least one action with respect to the multi-tier cache, wherein the at least one action is selected, at least in part, by at least one processor-based reinforcement learning model that evaluates (i) a state comprising one or more of a utilization metric for each tier of the multi-tier cache, a cache hit rate ratio of the multi-tier cache and at least one threshold for evaluating one or more of a similarity metric and a predicted reuse rate, and (ii) a reward based at least in part on one or more of a change in the cache hit rate ratio, a ratio of a number of language model calls to a total number of queries and a storage cost for at least one of the caching tiers of the multi-tier cache, wherein the at least one action comprises one or more of an adjustment to one or more of the utilization metric for one or more of the caching tiers of the multi-tier cache and the at least one threshold.

20. The non-transitory processor-readable storage medium of claim 19, further comprising scaling the reward based at least in part on a weight assigned to one or more of an organization and a user role.
